(19) United States
(12) Patent Application Publication
(10) Pub. No.: US 2013/0014640 A1
(43) Pub. Date: Jan. 17, 2013

(54) Laser peened fluid end for a high pressure pump

(71) Applicants: Tony M. Small, Fort Worth, TX (US); Daniel M. Perkins, Houston, TX (US); Danny C. Frank, Bedford, TX (US); David L. Capps, Crowley, TX (US)

(72) Inventors: Tony M. Small, Fort Worth, TX (US); Daniel M. Perkins, Houston, TX (US); Danny C. Frank, Bedford, TX (US); David L. Capps, Crowley, TX (US)

(73) Assignee: FRAC TECH SERVICES, LLC, Fort Worth, TX (US)

(21) Appl. No.: 13/180,627

(22) Filed: Jul. 12, 2011

(51) Int. Cl. F16J 10/02; B23Q 3/00; B23K 26/00

(52) U.S. Cl. 92/169.1; 219/121.85; 269/319

(57) ABSTRACT

A fluid end for a high pressure pump with improved resistance to fatigue failure is disclosed. Interior surfaces that are prone to fatigue failure are laser peened to resist cracking and other types of failures. A work holder for supporting the fluid end as it is peened is also disclosed.

### BACKGROUND OF INVENTION

1. Field of the Invention

This invention is for a fluid end for a high pressure fluid pump such as a pump used for supplying fracing fluid to an oil or gas well during a fracing procedure. Interior bore portions of the fluid end are laser peened to reduce the failure rate of the pumps due to interior cracks occurring at certain locations as the result of metal fatigue.

2. Description of Related Art

U.S. Pat. No. 7,484,452 discloses generally a high pressure pump with a fluid end 14. Tension members 22 are provided to address the high stresses and the fatigue failure at regions 36 shown in FIG. 4. The patent also discloses other prior art techniques have included “shoot peening compressive stresses at the crack location.”

U.S. Pat. No. 7,750,266 discloses the technique of laser peening a work part such as a wing skin for an airplane. A robot optical assembly 201 is mounted on a process platform 200 that can move along tracks 219. U.S. Pat. No. 7,573,001 discloses an improved method for laser peening a work piece 311 which may be a turbine blade from a jet engine. The laser disclosed in U.S. Pat. No. 7,573,001 is said to be capable of providing as much as ten times greater energy with a plus duration of one tenth of the prior art.

### BRIEF SUMMARY OF THE INVENTION

The invention disclosed and claimed in this application is for an improved fluid end for a high pressure pump. Interior portions of the fluid flow channels are laser peened to improve their resistance to failure as the result of fatigue cracks formed within the fluid end at certain locations as will be discussed in more detail herein.

### BRIEF DESCRIPTION OF THE SEVERAL VIEWS OF THE DRAWING(S)

FIG. 1 is a perspective view of a high pressure pump.

FIG. 2 is a perspective view of the fluid end of a high pressure pump.

FIG. 3 is a perspective view of one of the fluid chambers in the fluid end.

FIG. 4 is a sectional view of the interior of a fluid chamber.

FIG. 5 is a perspective view of the holder for the fluid end used during the peening process

### DETAILED DESCRIPTION OF THE INVENTION

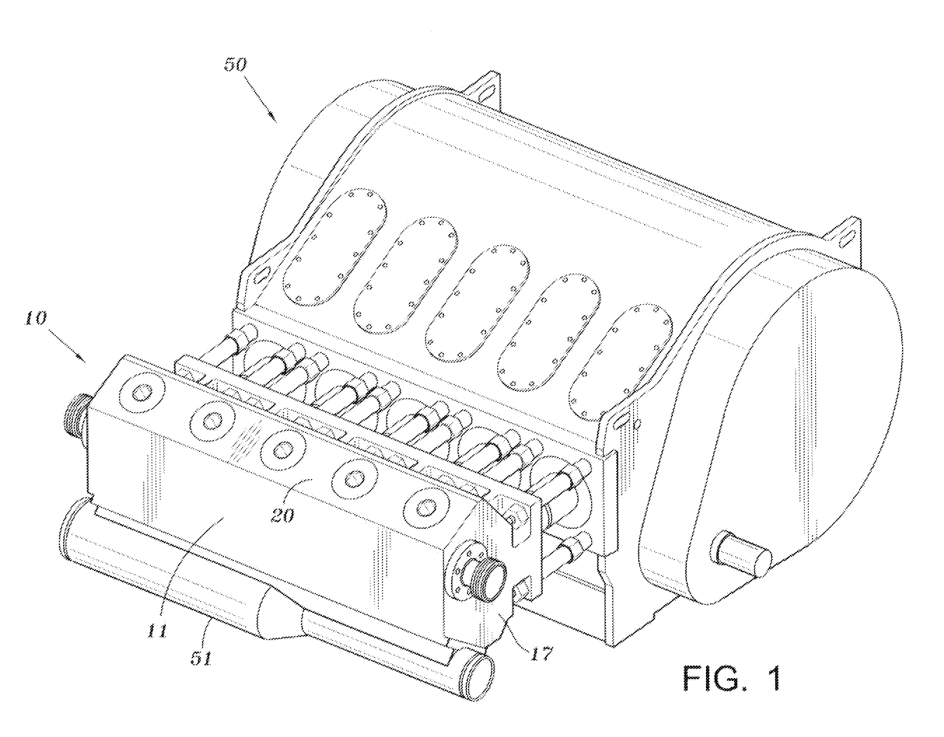

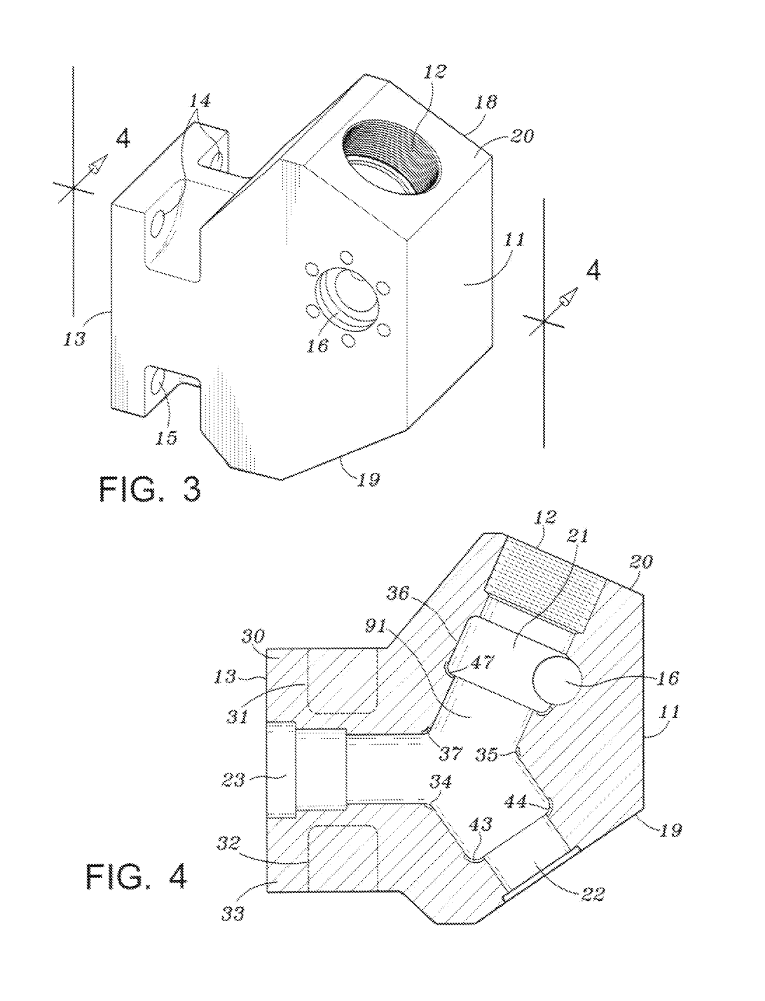

FIG. 1 illustrates a typical high pressure pump that includes a power end 50 that houses a series of gears and rods, and a fluid end 10 which may be formed of 4330 steel. Fluid end 10 includes a plurality of upper and lower holes 14 and 15 for securing the fluid end to the power end as shown in FIG. 3.

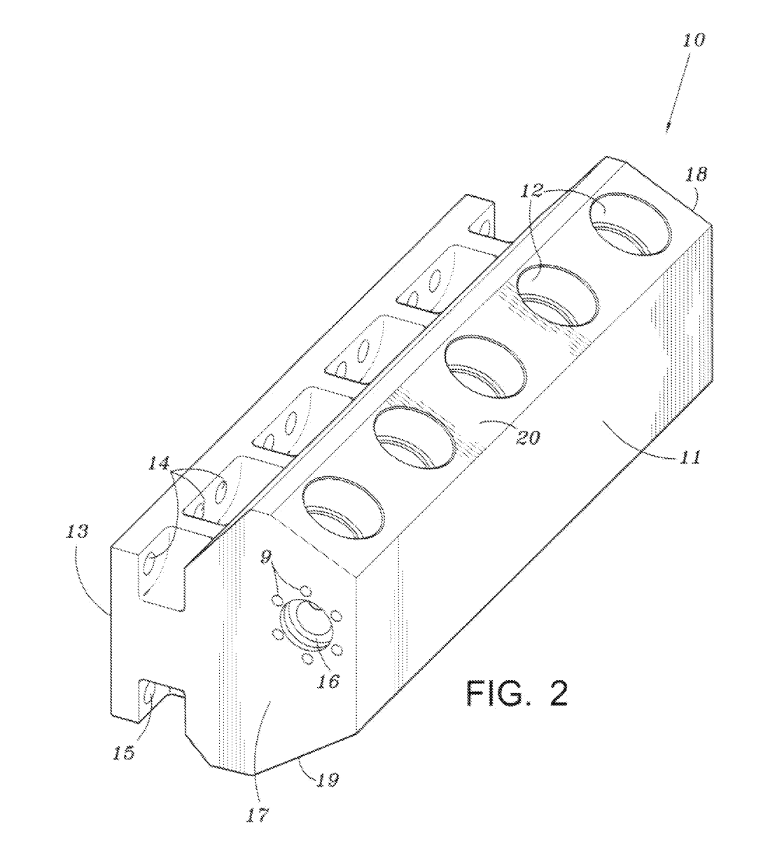

The fluid end as shown in FIG. 2 comprises a body member 11 including five fluid pumping chambers 91 (FIG. 4) each having an outlet bore 21 which is in fluid communication with a longitudinally extending outlet passageway 16. A plurality of holes 9 surround passageway 16 for receiving threaded studs or bolts. Each fluid chamber 91 as shown in FIG. 4 also includes an inlet bore 22 which is in fluid communication with a suction manifold 51. The fluid end also includes a plurality of bores 23 that receive a power piston for compressing the fluid within the fluid chamber 91. Each fluid chamber further includes an inlet and outlet valve at 22 and 21 respectively as is well known in the art. Experiences has shown that area 34, 35, 37, 43, 44, and 47 identified in FIG. 4 are subject to high rates of fatigue failure which results in cracks that render the pump inoperable. This causes extended down time for the fracing process and requires replacement of the fluid end both of which are very costly in terms of time and money.

The invention of the instant application includes laser peening of these areas using the high power/low pulse time of the latest laser peening technology as disclosed above.

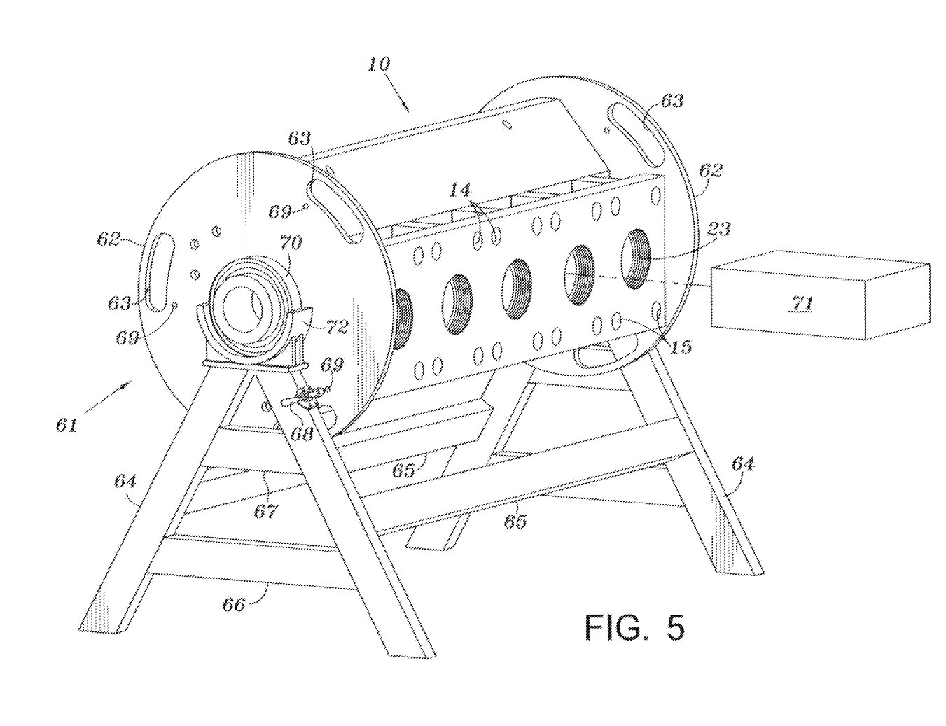

In order to accomplish this, a work piece holder 61 as shown in FIG. 5 for the fluid end has been developed.

Work holder 61 includes two circular discs 62 attached to both ends of the fluid end 10 by bolts extending from holes 9 in the fluid end. The fluid end and discs are rotably supported by a pair of bearings 70 and bearing supports 72 on in a pair of A-shaped supports 64 that are rigidly connected to each other via support bars 65. Openings 63 are provided in each of the discs to provide a handle for rotating the fluid end to the appropriate position. A retractable pin mechanism 68 is positioned on A-framed 64 which allows the pin to be inserted into one of the apertures 69 provided in the discs to allow the fluid end to be locked in a selected orientation.

In accordance with the invention a laser device 71, such as discussed above, is positioned such that the laser beam is directed through one of the bores 21, 22, and 23 toward the interior surface that is accessible through the bore.

Portion 35 of the fluid chamber 91 can be accessed by the laser through the piston bore 23. Portion 37 of the fluid chamber can be accessed through inlet bore 22. Portion 34 of the fluid chamber can be accessed through outlet bore 21, and portion 47 can also be peened through outlet bore 21. Portion 43 can be peened through outlet bore 12. Portion 44 can be peened through piston bore 23.

Suitable apparatus for peening the fluid end is disclosed in U.S. Pat. Nos. 7,750,266 or 7,573,001, the contents of which are hereby expressly incorporated herein by reference thereto.

The invention has been discussed with respect to a fluid end which as shown in the drawings is known as a Y-configuration defined by the geometry of the bores. However it is evident that the same principles could be applied to a fluid end which is known in the art as having a T or C configuration.

Although the present invention has been described with respect to specific details, it is not intended that such details should be regarded as limitations on the scope of the invention, except to the extent that they are included in the accompanying claims.

I claim:

1. A fluid end for a high pressure pump comprising:
a body member,
at least one inlet bore formed in the body member,
at least one outlet bore formed in the body member in fluid communication with the inlet bore,
at least one piston bore in which a power piston may be reciprocated; and
a portion of the inlet, outlet, or piston bore being laser peened so as to reduce structural failure due to fatigue stress.

2. A fluid end as claimed in claim 1 wherein the bores intersect each other so as to form a Y-configuration, and the interior surfaces of the bores that intersect each other are laser peened at the area of intersection.

3. A fluid end as claimed in claim 1 wherein the body member is formed from 4330 alloy steel.

4. A method of improving the reliability of a fluid end for a high pressure pump comprising:
providing a fluid end having at least one inlet, one outlet, and one power piston bore that intersect each other; and
laser peening a portion of any interior surfaces of at least one of the bores.

5. The method of claim 4 wherein the fluid end is held stationary during the peening process.

6. The method of claim 5 wherein the laser source is moved so as to direct discrete laser pulses to adjacent surfaces within a bore.

7. The method of claim 4 wherein the step of laser peening comprises directing discrete laser pulses at the target area.

8. A work holder for supporting an article to be processed comprising:
a pair of end supports connected to each other by support bars,
a bearing support located at a top portion of each end support,
a pair of circular discs adapted to be attached to ends of the article and each having a bearing adapted to be supported by the bearing support, and
means for locking the disks in a selected orientation with respect to the work holder.
